(19) United States
(12) Patent Application Publication
(10) Pub. No.: US 2026/0251502 A1
(43) Pub. Date: Aug. 27, 2026

(54) MULTIPOINT OPTICAL MEASURING DEVICE, AND ASSOCIATED USE AND METHOD

(71) Applicant: OFFICE NATIONAL D'ETUDES ET DE RECHERCHES AEROSPATIALES (ONERA), PALAISEAU (FR)

(72) Inventors: Michael SCHERMAN, PALAISEAU (FR); Elodie LIN, PALAISEAU (FR)

(73) Assignee: OFFICE NATIONAL D'ETUDES ET DE RECHERCHES AEROSPATIALES (ONERA), PALAISEAU (FR)

(21) Appl. No.: 19/161,810

(22) PCT Filed: Mar. 6, 2024
(86) PCT No.: PCT/EP2024/055805

§ 371 Date: Sep. 3, 2025

(30) Foreign Application Priority Data
Mar. 7, 2023 (FR) 2302089

(51) Int. Cl. G01J 3/42; G01J 3/02; G02B 5/30; G02B 27/28

(52) U.S. Cl. CPC G01J 3/42; G01J 3/0208; G01J 3/0224; G02B 5/3025; G02B 27/283

(57) ABSTRACT

A multipoint optical measuring device includes a source for emitting laser pulses, at least two splitting modules passed through by the pulses and to split an incident laser beam into a plurality of parallel beams, at least one converging lens interposed between the source and the splitting module, a measuring zone to receive a medium or sample to be measured and located in a focal plane of the converging lens, each splitting module includes a first uniaxial birefringent crystal and an identical second crystal placed after the first crystal on the path of the pulses, the first birefringent crystal splits an incident laser beam into an ordinary secondary beam and an extraordinary secondary beam, the second birefringent crystal oriented with respect to the first crystal so that the extraordinary secondary beam obtained from the laser beam takes an ordinary path through the second birefringent crystal.

### TECHNICAL FIELD

The present invention relates to the field of optical metrology.

A multipoint optical measuring device is proposed, as well as a method implemented by means of this device.

It finds a particularly advantageous application in laser spectroscopy measurements in an unsteady flow or else for hyperspectral or multiphoton microscopy measurements.

### PRIOR ART

Conventionally, laser diagnostic technologies are based on the acquisition and the analysis of the response of a medium to laser excitation, in order to deduce physico-chemical status data (temperature, composition, concentrations, etc.) characterizing this medium. These status data are deduced from characteristics such as the amplitude, the polarization or the spectrum of the laser beam reflected by the medium or transmitted therethrough or even from such characteristics of a light beam generated by the medium.

For spatially resolved measurements, the laser beam is focused on a point in the medium using a lens (macroscopic measurement) or a microscope objective (microscopic measurement). The data is then collected at this focal point, so that the collected data comes from a restricted measurement volume of the medium, and the analysis of this collected data provides local information on the medium analyzed. If the medium is heterogeneous, this information is fragmented and it is necessary to multiply the measurements at different points to accurately describe the medium.

The medium analyzed may be stationary, when it evolves slowly with respect to the measuring rate, or unsteady (optionally turbulent), when it evolves rapidly with respect to this rate.

In the first case, the use of a single measuring point is possible, for example by scanning the measurement volume or by moving the sample of the medium measured in front of the laser beam.

Such operation can be very time-consuming, which can be limiting for some applications. Spatial scanning of a single point can take a long time on some large samples or if the signal to be analyzed is not very intense and requires long integration times per point. In order to increase this speed, it is of obvious interest to survey several points in parallel, scanning different zones of the sample.

On the other hand, in the case of unsteady media, which evolve rapidly with respect to the measuring rate, the spatial scanning method proves ineffective and it is necessary to extend the measuring dimension in order to characterize it effectively.

Measurements carried out simultaneously at multiple points, along a line (intersection of a laser sheet and the sample or of two laser sheets) or in a plane (intersection of a laser sheet and a volume beam) have already been proposed.

Nevertheless, these solutions can be complex to implement, and require considerable laser power. This is the case notably for example when the measurement uses multi-photon interactions.

Additionally, by distributing energy along a laser sheet, the peak powers reached at the sample of the medium analyzed decrease proportionally, and the depth of field can also be degraded, which results in a loss of spatial resolution of the data.

Other techniques have also been proposed, which use for example diffractive patterns (etched or acousto-optic gratings, fixed or programmable phase masks), microlens arrays and arrays of adjustable micromirrors. In addition to sometimes low energy efficiency (as in the case of micromirror arrays), these techniques are also complex to implement. They suffer from two main handicaps:
in the case of ultra-short optical pulses, used notably for multi-photon spectroscopy, the laser spectrum is broad. However, the diffraction pattern depends on the wavelength and therefore spatially and temporally disperses the laser pulses. These patterns can optionally be adapted to certain wavelength ranges, and must be modified if the targeted spectral range varies;
these systems make it difficult or impossible (in the case of microlens arrays) to use the potentially complex multi-beam excitation geometries required to perform certain multi-photon spectroscopies with demanding phase-tuning conditions (for example the BOXCAR configuration for coherent anti-Stokes Raman scattering spectroscopy or degenerate four-wave mixing).

### DISCLOSURE OF THE INVENTION

One general aim of the invention is to remedy the above-mentioned shortcomings.

Another aim of the invention is to propose a multipoint measuring solution which is simple to implement and which is adaptable to many types of laser diagnostics/measurements, whether single or multiple photon exciters.

To this end, the invention proposes a multipoint measuring device comprising:
a source for emitting laser pulses,
at least two splitting modules intended to be passed through by said pulses and to split an incident laser beam into several parallel beams,
at least one converging lens that is interposed between the source and the splitting module,
a measuring zone that is intended to receive a medium or sample to be measured and that is located in a focal plane of said converging lens.

The measuring device is such that each splitting module comprises, on the one hand, a first uniaxial birefringent crystal and, on the other hand, an identical second crystal placed after the first crystal on the path of the pulses, the first birefringent crystal being configured to split an incident laser beam into an ordinary secondary beam and an extraordinary secondary beam, the second birefringent crystal being oriented with respect to the first crystal so that the extraordinary secondary beam obtained from the laser beam takes an ordinary path through the second birefringent crystal, and so that the ordinary secondary beam obtained from the laser beam takes an extraordinary path through the second birefringent crystal, the pulses of the beams output from the modules reaching simultaneously and at multiple points the medium or sample to be measured.

Such a measuring device generates a plurality of measuring points and guarantees a better depth of field of measurement with respect to existing techniques. It can be easily adapted, notably to a change in the wavelength of the beams used or to restrictions on the geometry of the exciter beams (phase matching). Such a device is further relatively easy to implement and allows existing laser systems to be used. It makes it possible to respond to a variety of experimental situations and is easy to transport.

This device is advantageously completed by the following features taken alone or in all their technically possible combinations:
the optical axis of the second crystal of each splitting module is rotated by 90° with respect to the optical axis of the first crystal of the same splitting module,
the source is configured to emit a polarized laser beam, the first crystal of each module being oriented so that the polarization of the incident beam comprises two non-zero components along the polarization axes of the ordinary and extraordinary secondary beams of said first crystal,
the device comprises a succession of several splitting modules interposed on the path of the beams between the converging lens and the location of the medium or sample to be measured, said succession of splitting modules extending on the path of the pulses over a distance less than the focal length of the converging lens multiplied by the average index seen by the incident laser beam in each birefringent crystal,
a waveplate is interposed between two successive splitting modules, said waveplate being adapted to rotate the polarization of the beams it receives by +/−45° or to make it circular,
the device comprises a succession of N splitting modules split in pairs by a waveplate, where N is an integer, the crystals of the different splitting modules having different thicknesses from one module to another, said succession of modules generating 2^{N} measuring points arranged in line on the medium or sample to be measured,
a waveplate is a half-waveplate or a quarter-waveplate,
the device comprises a succession of N splitting modules, where N is an integer, the successive splitting modules having their own optical axes rotated every other time by +/−45° in the plane orthogonal to the axis of direction of the pulses, said succession of modules generating a grid of 2^{N} measuring points on the medium or sample to be measured,
the thickness of the crystals of a first splitting module, which is upstream of a second splitting module arranged downstream on the path of the beams, is of a value equal to the product of the thickness of the crystals of said second module and of a predetermined multiplier,
the predetermined multiplier is 2 or 1/√2,
the first and the second crystal of a splitting module are two stacked plates,
the pulses emitted by the source are sub-picosecond pulses.

The invention further relates to the use of a multipoint measuring device as defined hereinbefore for a laser spectroscopy measurement in a stationary or unsteady or optionally turbulent flow and to the use of a multipoint measuring device as defined hereinbefore for a hyperspectral or multiphoton microscopy measurement.

Finally, the invention relates to a multipoint optical measuring method, wherein
a medium or a sample to be measured is excited at several points by a multipoint optical measuring device as defined hereinbefore,
a response from the medium or sample to be measured is recorded by a matrix or sequential detector or a fiber optic bundle, and
the response is analyzed to deduce physico-chemical parameters at each excited point.

### DESCRIPTION OF FIGURES

Further features, purposes and advantages of the invention will become apparent from the following description, which is purely illustrative and non-limiting, and which should be read in conjunction with the appended drawings whereupon:

FIG. 1 schematically shows an example of a multipoint optical measuring device according to one embodiment;

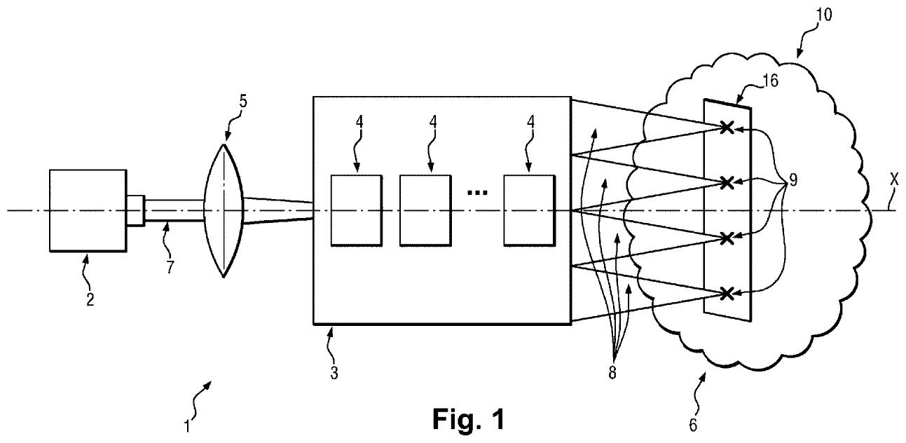

FIG. 2 shows a splitting module according to one embodiment;

FIG. 3 shows an example of a splitting system with two splitting modules according to a first embodiment;

FIG. 4 shows an example of a splitting system with two splitting modules according to a second embodiment;

FIG. 5 shows an example of a splitting system with 2, 3 and N splitting modules based on a generalization of the example exemplified in FIG. 3;

FIG. 6 shows an example of a splitting system with 2, 3, 4 and N splitting modules based on a generalization of the example exemplified in FIG. 4;

FIG. 7 shows an example of a splitting system with N splitting modules according to a third embodiment;

FIG. 8 shows an example of a splitting system with 2 and its generalization with N splitting modules according to a fourth embodiment;

FIG. 9 is a flowchart of steps of a method according to one embodiment of the invention.

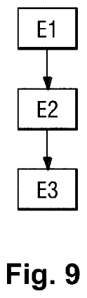

On all the figures, similar elements bear identical references.

### DETAILED DESCRIPTION OF THE INVENTION

A multipoint optical measuring device 1 comprises a light source 2, a splitting system 3 comprising at least two splitting modules 4, a converging lens 5, and a measuring zone 6.

Light source 2 is a laser source. In particular, the source 2 is configured to emit laser pulses, which may be so-called ultrashort pulses. For example, the pulses can be of sub-picosecond duration, and in particular of the femtosecond order.

The light source 2 is configured to emit an incident laser beam 7 along a given path towards the splitting modules 4 of the splitting system 3.

Additionally, the incident laser beam 7 generated during a pulse emitted by the source 2 is for example polarized (the polarizations are shown in the figures by arrows extending from the beams).

In the present application, the direction of propagation of the incident laser beam 7 and more generally of the pulses emitted by the source 2 is defined by an oriented X axis, the upstream and downstream being defined with respect to the direction of propagation of the incident laser beam 7 emitted by the source 2 in operation.

The splitting system 3, and more particularly the splitting modules 4, are thus intended to be passed through by the incident laser beam 7 emitted by the source 2, and more generally by all the pulses emitted by the source 2. Each splitting module 4 is configured to split an incident laser beam passing therethrough, such as beam 7, into several separate beams based on the polarization of said incident laser beam, so that the splitting system 3 is configured to split the incident laser beam 7 into a number of separate beams 8 depending on the number of splitting modules 4 comprised in said system 3. The split beams 7 at the output of a splitting module 4 and/or of the splitting system 3 are parallel therebetween and a given distance apart.

The converging lens 5 comprises for example a long-focus converging lens for macroscopic work, or may comprise a microscope objective for microscopic work. The converging lens 5 is configured to converge each of the split beams 8 at several focal points 9 (corresponding to the measuring points), since no two split beams 8 converge at the same focal point 9. For this purpose, the converging lens 5 is for example arranged between the source 2 and the splitting system 3, so that the incident laser beam 7 emitted by the source 2 passes therethrough in the direction of the splitting system 3.

The split beams 8 output from the splitting system 3 therefore converge at a plurality of focal points 9.

The measuring zone 6 is intended to receive a medium or sample 10 to be measured. In order to perform a quality measurement, the measuring zone 6 is arranged in a zone comprising the focal plane 16.

Each splitting module 4 comprises a first uniaxial birefringent crystal 11a and a second uniaxial birefringent crystal 11b. Thus, each of the first and second crystals 11a, 11b comprises a single optical axis 12. Additionally, each of the first and second crystals 11a, 11b comprises an ordinary path 13 and an extraordinary path 14, an incident polarized beam passing through one of the crystals 11a, 11b being, depending on its polarization, split on passing through said crystal 11a, 11b into an ordinary beam taking the ordinary path 13 and an extraordinary beam taking the extraordinary path 14. The two ordinary and extraordinary beams are then orthogonally polarized and distanced from each other at the exit of the crystal 11a, 11b, so that their respective focal points are transversely distanced from each other by a distance depending on various elements including the thickness of the crystal 11a, 11b, an arrangement of the crystal 11a, 11b with respect to the angle of incidence of the incident beam, and the nature of the birefringent crystal 11a, 11b. More precisely, the ordinary beam is polarized perpendicular to the optical axis 12 of the crystal 11a, 11b, while the extraordinary beam is polarized in a plane containing the optical axis 12 of the crystal 11a, 11b.

The first uniaxial birefringent crystal 11a is arranged on the path of the laser pulses emitted by the source 2, and therefore on the path of the laser beam 7, that is on the X axis, so that the first crystal 11a is configured to split the incident laser beam 7 into an ordinary secondary beam 15a and into an extraordinary secondary beam 15b each following a path substantially parallel to the X axis. The ordinary 15a and extraordinary 15b secondary beams are therefore polarized orthogonally to each other (the ordinary secondary beam 15a being polarized in a plane perpendicular to the optical axis 12 of the crystal 11a and the extraordinary secondary beam 15b being polarized in a plane containing the optical axis 12 of the crystal 11a).

The second crystal 11b is arranged next to (downstream of) the first crystal 11a on the path of the ordinary and extraordinary secondary beams 15a, 15b. In one embodiment, the second crystal 11b is arranged in downstream contact with the first crystal 11a. Alternatively, a space can be provided between the two crystals 11a, 11b.

The first and second crystals 11a, 11b of the same splitting module 4 are identical. In other words, the first and second crystals 11a, 11b of the same splitting module 4 have the same nature, the same waist angle, the same ordinary and extraordinary refractive indices, the same size and the same thickness. For example, the first and second crystals 11a and 11b of each of the splitting modules 4 are Calcite (CaCO₃) or Yttrium Orthovanadate (YVO4) plates or any other suitable birefringent crystal.

Additionally, the second crystal 11b of a splitting module 4 is oriented with respect to the first crystal 11a so that the ordinary secondary beam 15a passes through the extraordinary path 14 of the second crystal 11b and that the extraordinary secondary beam 15b passes through the ordinary path 13 of the second crystal 11b.

In one embodiment, the incident laser beam 7 is for example polarized at 45° to the polarization of the ordinary secondary beam 15a of the first crystal 11a and the second crystal 11b is for example oriented with respect to the first crystal 11a so that the optical axis 12 of the second crystal 11b is rotated 90°with respect to the optical axis 12 of the first crystal 11a. This configuration of the incident beam 7 allows it to be split into two secondary beams 15a, 15b of equal intensity. In certain situations, it may be advantageous to have beams of different intensities, for example in gaseous media having cold and hot zones.

Thus, each of the secondary beams 15a and 15b follows an ordinary path and an extraordinary path, so that each of these secondary beams 15a, 15b experiences exactly the same disturbances between the source 2 and the measuring zone 6. Thereby, the two secondary beams 15a, 15b converge respectively at a first and a second point 9 located on the focal plane 16. Similarly, the two secondary beams 15a, 15b are synchronized in time, that is the two secondary beams 15a, 15b experience the same group velocity dispersions.

In other words, the second crystal 11b compensates for any different group velocity dispersions and axial position shifts between points 9 of the two secondary beams 15a, 15b induced by the first crystal 11a. Thereby, the two focal points 9 can be measured simultaneously in the same plane 16, this plane being the focal plane 16 located at a focal length of the converging lens 5.

### 1^{st} Embodiment With Two Splitting Modules 4 (so That the Measuring Points 9 are all Aligned in the Focal Plane 16)

This principle can be generalized by arranging several splitting modules 4 in series on the optical path of the incident beam 7 and secondary beams 15a, 15b, so as to obtain more focal points 9 distributed on the same plane 15 perpendicular to the X axis.

For example, in one embodiment, the splitting system 3 may comprise a first and a second splitting module 4 successively in series from upstream to downstream between the source 2 and the measuring zone 6.

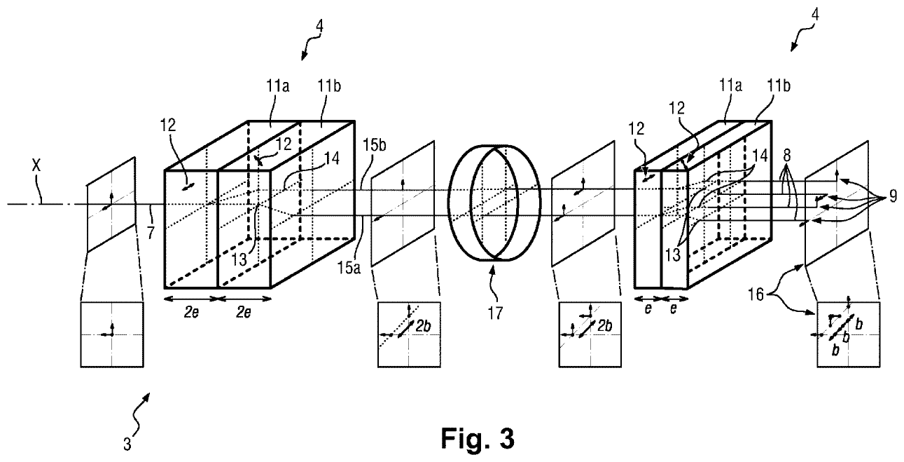

In a first embodiment with two splitting modules 4 in series, an example of which is shown in FIG. 3, the splitting system 3 comprises a waveplate 17 interposed between the two splitting modules 4. FIG. 3 also shows an example of the polarization states of the various beams 7, 15a, 15b, 8 at different positions of said beams as they pass through the splitting system 3, the polarization states being represented on planes perpendicular to the X axis.

The waveplate 17 is configured to modify the polarization of the secondary beams 15a and 15b from the first splitting module 4, so that each of the secondary beams 15a and 15b incident on the second splitting module 4 has a polarization that splits again into two beams as it passes through the second module 4. For example, the waveplate 17 is configured to rotate the polarization of the two beams passing therethrough by 45°in the same direction, clockwise or counter-clockwise.

In this first embodiment, the secondary beams 15a and 15b pass through the waveplate 17 then pass through the second splitting module 4, since the second splitting module 4 is arranged on the path of the secondary beams 15a, 15b.

The crystals 11a, 11b of the first splitting module 4 have a different thickness to the thickness of crystals 11a, 11b of the second splitting module 4.

In this fashion, each of the secondary beams 15a, 15b is split by the second module 4 into two separate beams 8, that is at the output of the second module 4, four separate beams 8 converge at four separate focal points 9 synchronized in time and arranged in the same plane 16 perpendicular to the X axis, this plane being the focal plane of the converging lens 5. In this first embodiment, the four focal points 9 are aligned therebetween due to the use of the waveplate 17, and the use of different thicknesses of crystal for the two modules 4.

For example, the crystals 11a, 11b of the first splitting module 4 are twice as thick as the crystals 11a, 11b of the second splitting module 4. In this fashion, the four focal points 9 are arranged in the plane 16 in an equidistant fashion and aligned.

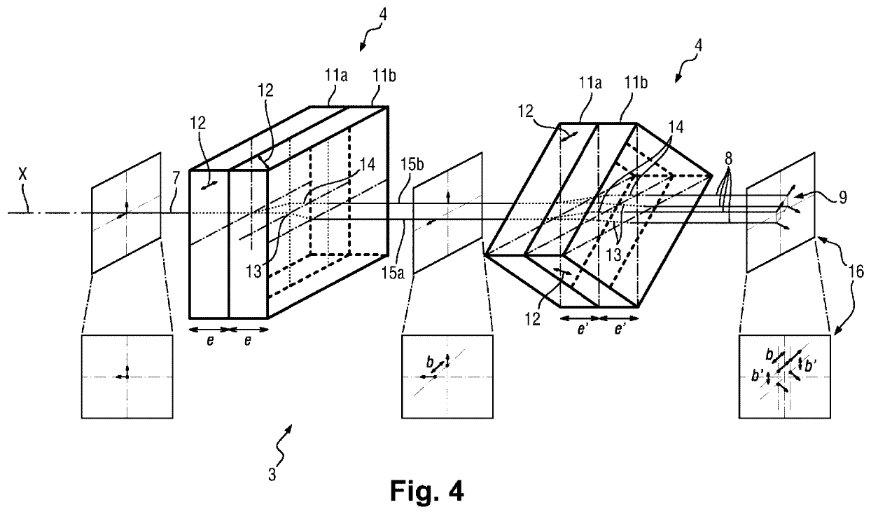

In the example shown in FIG. 3, as well as in FIGS. 4, 5, 6, 7 and 8, the thicknesses of each of the crystals 11a, 11b are indicated based on the reference e, worth a predetermined thickness. Thus, 2e means double the thickness e, etc. In this example shown in FIG. 3, the thicknesses are thus selected to be double from one module 4 to the next, so that the focal points 9 on the focal plane 16 are equidistant by a distance denoted b.

### 2^{nd} Embodiment With Two Splitting Modules 4 (So That the Measuring Points 9 Form a Grid of the Focal Plane 16)

In a second embodiment with two splitting modules 4, an example of which is shown in FIG. 4, the splitting system 3 lacks a waveplate 17. FIG. 4 also shows an example of the polarization states of the various beams 7, 15a, 15b, 8 at different positions of said beams as they pass through the splitting system 3, the polarization states being represented on planes perpendicular to the X axis. On the other hand, in this second embodiment, the second splitting module 4 arranged downstream of the first module 4 can be rotated with respect to the first splitting module 4 in a plane perpendicular to the X axis. In other words, in this alternative embodiment, the second splitting module 4 has optical axes 12 of the crystals 11a, 11b rotated about the same axis X with respect to the optical axes 12 of the crystals 11a, 11b of the first splitting module 4 arranged upstream, this rotation being different by a multiple of 90°, so that the first crystal 11a of the second module 4 is not oriented identically to the second crystal 11b of the first module 4. Indeed, if this were the case, the first crystal 11a would not split the secondary beams 15a, 15b from the first module 4 into two beams each, because the polarizations of the secondary beams 15a, 15b would correspond to the optical axis 12 of the first crystal 11a of the second module 4.

For example, the optical axis 12 of the first crystal 11a, respectively of the second crystal 11b, of the second splitting module 4 is rotated by 45°clockwise with respect to the optical axis 12 of the first crystal 11a, respectively of the second crystal 11b of the first splitting module 4.

In this embodiment, the crystals 11a, 11b of the first splitting module 4 have a thickness e different from the thickness e′ of the crystals 11a, 11b of the second splitting module 4. Thus, the focal points 9 form a 4-point grid, that is they form the vertices of a parallelogram whose adjacent sides are of two different lengths b and b', due to the different thicknesses selected e and e'.

In this embodiment, the two secondary beams 15a, 15b from the first module 4 thus pass through the second module 4 by being polarized orthogonally with respect to each other.

As the first crystal 11a of the second module 4 is rotated with respect to the second crystal 11b of the first module 4, the first crystal 11a of the second module 4 is therefore configured to split each of the beams 15a, 15b into two separate beams 8, that is that at the output of the second module 4, four separate beams 8 converge at four separate time-synchronized focal points 9 arranged in the same focal plane 16 perpendicular to the X axis. More precisely, in this embodiment, the four focal points 9 form a grid of the focal plane 16. In other words, the four focal points 9 are the vertices of a parallelogram in the focal plane 16.

Generalization of the 1st embodiment with N splitting modules 4, N being a positive integer (so that the measuring points 9 are all aligned in the focal plane 16):

These two embodiments disclosed with two splitting modules 4 can be generalized with N splitting modules 4, where N is a positive integer. In an embodiment with N splitting modules 4, the splitting system 3 comprising N modules 4 splits the incident laser beam 7 into 2^{N} separate beams 8, each of the separate beams 8 converging at a separate focal point 9. The 2^{N} focal points 9 of such an embodiment with N splitting modules 4 are all arranged in the focal plane 16.

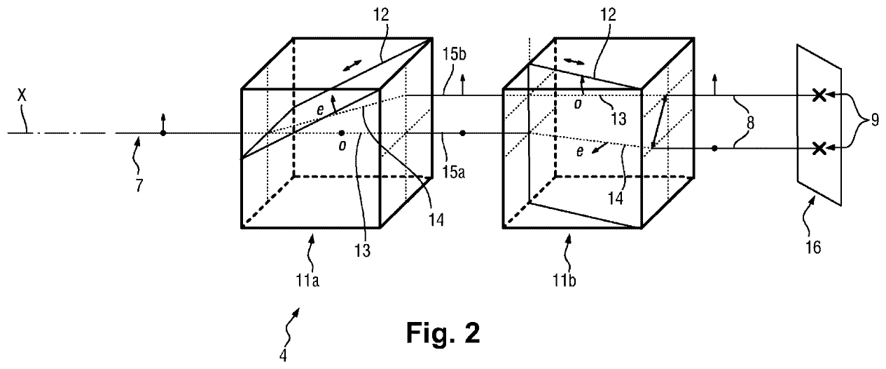

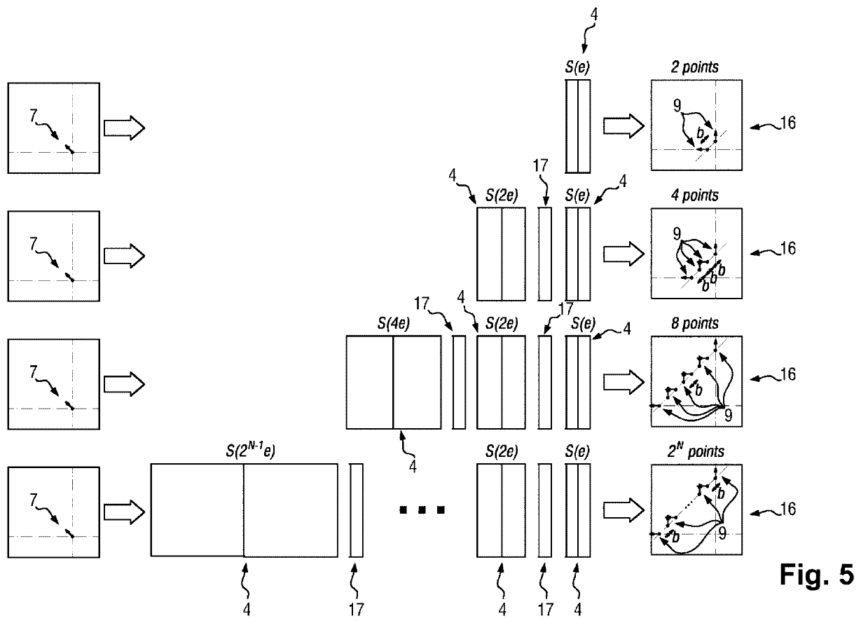

FIG. 5 shows a generalization of the first embodiment from the example shown in FIG. 3. More particularly, FIG. 5 shows an example of this first embodiment with 2, 3 and N splitting modules, the 2-module case being the example shown in perspective on FIG. 3. FIG. 5 also schematically shown the splitting module 4 shown in FIG. 2.

In a generalization of the first embodiment with N splitting modules 4, exemplified in the last line at the bottom of FIG. 5, the splitting system 3 comprises N splitting modules 4 successively arranged on the path of the incident 7 and secondary laser beams from the various modules 4. Thus, for the sake of simplicity, the N splitting modules 4 are arranged in succession along the X axis.

In this embodiment, the splitting system 3 comprises a waveplate 17 arranged between each splitting module 4. In other words, the system 3 comprises N-1 waveplates 17, the N splitting modules 4 being split in pairs by a waveplate 17 interposed between two successive modules 4.

The waveplates 17 are identical, and are for example half-waveplates or quarter-waveplates. In particular, the waveplates 17 can be configured to rotate the polarization of the beams passing therethrough by 45° clockwise or counter-clockwise, or alternatively to make said polarization circular.

Furthermore, in this embodiment, the crystals 11a, 11b of each of the N splitting modules 4 have a thickness different from the thickness of the crystals 11a, 11b of each of the N-1 other splitting modules 4, in order to distribute the 2^{N} focal points 9 of the separate beams 8 at the output of the system 3 along a straight line in plane 16.

Optionally, the crystals 11a, 11b of each of the N modules have twice the thickness of the crystals 11a, 11b of the splitting module 4 directly arranged downstream, so that the focal points 9 of the split beams 8 at the output of the splitting system 3 are aligned and equidistant. In the examples shown in FIG. 5, the thicknesses of the crystals 11a, 11b are indicated based on the reference e, representing a predetermined thickness. In the examples shown in FIG. 5, the thicknesses are thus selected to be double from one module 4 to the next, so that the focal points 9 on the focal plane 16 are equidistant by a distance denoted b.

### Generalization of the 2^{nd} Embodiment Mode With N Splitting Modules 4, N Being a Positive Integer (So That the Measuring Points 9 Form a Grid of the Focal Plane 16)

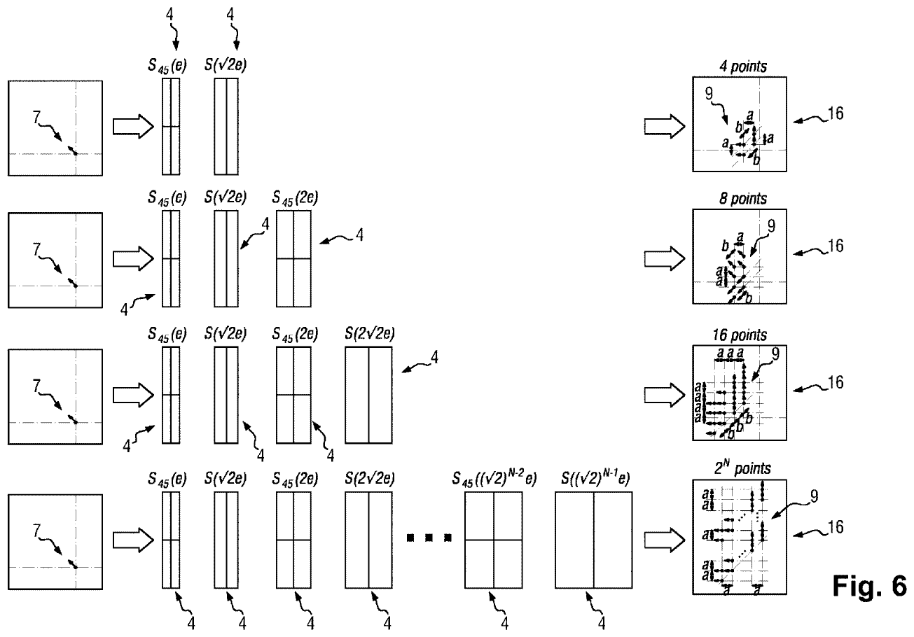

FIG. 6 schematically shows the example of the second embodiment shown in FIG. 4, as well as a generalization with 3, 4 and N splitting modules 4 of the second embodiment from the example shown in FIG. 4.

In this generalization of the second embodiment with N splitting modules 4, the N splitting modules 4 are rotated with respect to one another in a plane perpendicular to the X axis, that is the crystals 11a, 11b of a module 4 are rotated along the X axis with respect to a directly adjacent module 4. For example, the optical axis 12 of the first crystal 11a, respectively of the second crystal 11b, of one of the N splitting modules 4 is rotated by 45° clockwise or counterclockwise with respect to the optical axis 12 of the first crystal 11a, respectively of the second crystal 11b of the directly adjacent upstream splitting module 4 and of the directly adjacent downstream splitting module 4, the two directly adjacent upstream and downstream splitting modules 4 respectively being both identically oriented. In other words, for any group of directly successive first, second and third splitting modules 4 of the N splitting modules 4 of the system 3, the first and the third modules 4 have an identical orientation, and the second is rotated in a plane perpendicular to axis X with respect to the first and to the third modules 4 by an angle equal to 45° clockwise or counterclockwise. To clarify the orientations of the modules 4, a notation S and a notation S45 are used in FIG. 6, the S notation designating a module oriented by default, and the S45 notation designating a module oriented at 45° with respect to a module 4 designated by the S notation. In addition, the thicknesses of the individual crystals are shown in brackets.

In this embodiment, the crystals 11a, 11b of each of the splitting modules 4 have a thickness different from the crystals 11a, 11b of the respective thicknesses of the other N-1 splitting modules 4.

In this embodiment, the 2^{N} separate beams 8 resulting from the succession of N splitting modules 4 are arranged in the same focal plane 16 so as to form a grid of the plane 16.

Optionally, the thicknesses of the crystals 11a, 11b of one of the splitting modules 4 can be defined as the product by a predefined multiplier (this multiplier being for example the square root of 2 in FIG. 6) of the thickness of the crystals 11a, 11b of the directly adjacent splitting module 4, for example upstream, so that the 2^{N} split beams 8 converge at focal points 9 regularly spaced from one another. For example, the thickness of the crystals 11a, 11b of any of the modules 4 can be the product of a multiplier, for example 2 or 1/√2, by the thickness of the crystals 11a, 11b of the adjacent splitting module 4 arranged directly downstream. In the particular case of FIG. 6, with a multiplier equal to 1/√2, a grid of points with a square mesh is obtained.

In all embodiments, the number of splitting modules 4 successively arranged in the splitting system 3 is limited. More precisely, an overall distance along the X axis between the first splitting module 4 arranged upstream of the other modules 4 and the last splitting module 4 arranged downstream of the other modules 4 must be less than a limit equal to the focal length of the converging lens 5 multiplied by an average refractive index of the splitting modules 4 of the system 3, this average index being defined as the average of the extraordinary and ordinary indices of a splitting module 4 of the system 3, the modules 4 of the system 3 being identical to one another apart from their respective thickness. More precisely, the last splitting module 4 of the splitting system 3, that is the splitting module 4 arranged furthest downstream from the source 2, must be arranged axially along X at a point between the source 2 and a point on the X axis distant downstream from the converging lens 5 by a distance equal to the focal length of the converging lens 5 multiplied by the average refractive index of the splitting modules 4 of the system 3 as defined hereinbefore.

In other embodiments, the relationships between the thicknesses and/or between the orientations of the different splitting modules 4 can be modified in order to generate focal points 9 distributed differently in the focal plane 16.

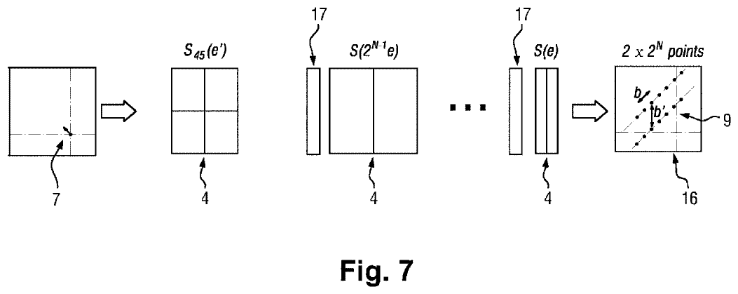

Furthermore, in a third embodiment, the splitting system 3 can comprise modules 4 oriented with respect to one another, for example by 45°, and waveplates 17, in order to generate focal points 9 forming an irregular spatial arrangement in the focal plane 16. An example of this third embodiment is exemplified in FIG. 7, wherein the system 3 comprises a sequence of modules 4 each split by a waveplate 17, and a further module 4 oriented with respect to the sequence of modules 4, for example at 45°, with a further waveplate 17 being arranged between the module 4 oriented at 45° which is arranged upstream, and the arrangement of modules 4 arranged downstream. Thus, as shown in FIG. 7, the focal points 9 produced on the plane 16 form two parallel straight lines spaced apart by a distance b′ (depending on the thickness e′ selected for the crystals of the module 4 oriented at 45°), the points 9 of the same straight line being evenly spaced due to the choice of a doubled thickness between successive modules 4 from downstream to upstream of the arrangement.

An irregular arrangement of focal points 9 can be judicious for the study of a medium 10 such as a flow evolving with strong gradients in certain zones or weak gradients in others, or such as very heterogeneous samples in certain zones or homogeneous samples in others. More precisely, it may then be useful to generate focal points 9 that are more numerous and narrower in the zones with strong gradients or high levels of heterogeneity, and less numerous and narrower in other less unstable zones.

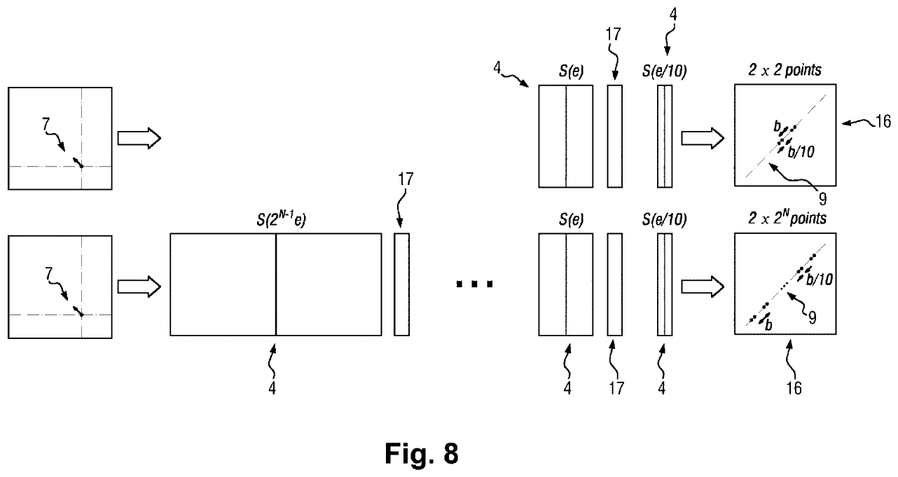

For example, in a fourth embodiment, an example of which is shown in FIG. 8, in order to measure a gradient of a parameter at several locations in a flow, the measuring device 1 can be configured to produce several pairs of focal points 9 wherein the two focal points 9 of a single pair are very close together, and wherein two pairs of focal points 9 are relatively spaced apart, so as to cover a large distance in the plane 16. More precisely, to form such a device 1, the modules 4 of this device are specifically configured. In particular, the thicknesses of the crystals 11a, 11b of the modules 4 of such a device 1 can be very different from one module 4 of the system 3 to the adjacent module 4.

Thus in the example shown in FIG. 8, the thickness of the crystals 11a, 11b of one module 4 is a multiple of 10 of the thickness of the crystals 11a, 11b of the next downstream module 4.

The measuring device 1 allows point measurements at the focal plane 16 from a single beam emitted by the source 2. The generation of such focal points 9 guarantees the depth of field of measurement. Indeed, the laser energy emitted by the source 2 is not dissipated in unnecessary zones as is the case when using a laser sheet, and is concentrated in the focal points 9, which guarantees sufficient peak power of pulses in the measuring zone 6. In other words, the proposed measuring device 1 guarantees the focusing quality of pulses while saving the laser energy emitted to achieve such a result. A measuring device 1 according to the present disclosure can be used to perform laser spectroscopy measurements, for example of an unsteady flow such as turbulent jets, combustions or plasmas.

Such a measuring device 1 according to the present disclosure can also be used to perform hyper-spectral or multi-photon microscopy measurements.

Indeed, the measuring device 1 according to the present disclosure makes it possible to generate time-synchronized focal points 9 and arranged in the same axial position along the X axis, so that the measuring volumes associated with each focal point 9 have the same depth of field and have the same axial position, which is essential, notably in the case of using the measuring device 1 in microscopy, where economy and space management are very important.

The crystals 11a, 11b of each splitting module 4 can thus be simple stacked plates.

The thicknesses of these crystals 11a, 11b can thus belong to different ranges depending on the desired experimental situations. For example, to carry out measurements on a microscopic scale, since microscope objectives have very small working lengths, the crystals 11a, 11b can be simple plates whose thickness can vary between the modules 4 in the micrometer range, for example between 30 and 300 micrometers. Conversely, for macroscopic measurements, thicker crystals 11a, 11b can be used, in particular when the converging lens 5 used has a long focal length. For example, in these macroscopic applications, the thicknesses of the crystals 11a, 11b of the splitting modules 4 can be between 0.1 and 100 millimeters.

These examples are not limiting, and other thicknesses of crystals 11a, 11b can be selected according to the desired applications.

A method of multipoint optical measurement using a measuring device 1 according to the present disclosure will now be disclosed.

In a step E1, the medium or sample to be measured 10 is excited at several points by the device 1. In particular, a laser pulse comprising a laser beam such as the laser beam 7 is emitted by the source 2. The laser beam 7 passes successively through the converging lens 5 and the splitting system 3, and emerges split into a plurality of separate beams 8 converging at focal points 9 arranged in the plane 16 at the level of the medium or sample 10.

In step E2, a response from the medium or sample 10 is recorded by a matrix detector (for example a spectrometer), sequential detector (for example a photodiode array, or several aligned spectrometers) or a fiber optic bundle, before this response is analyzed in step E3 in order to deduce physico-chemical parameters of the medium or sample 10 such as for example the temperature, the concentration or the chemical composition. Indeed, the use of a detector such as a spectrometer makes it possible to obtain a spectrum of the reaction of the medium or sample 10 to laser excitation based on the measuring position in the medium or sample 10. By analyzing such a spectrum, it is possible to deduce the local temperature at the measuring point of the medium or sample 10, the local concentration or the local composition for example.

1-15. (canceled)

16. A multipoint optical measuring device comprising:
a source for emitting laser pulses;
at least two splitting modules intended to be passed through by said pulses and to split an incident laser beam into several parallel beams;
at least one converging lens interposed between the source and the splitting module;
a measuring zone that is intended to receive a medium or sample to be measured and that is located in a focal plane of said converging lens, wherein each splitting module comprises, on the one hand, a first uniaxial birefringent crystal and, on the other hand,
a second identical crystal placed after the first crystal on the path of the pulses, the first birefringent crystal being configured to split an incident laser beam into an ordinary secondary beam and an extraordinary secondary beam, the second birefringent crystal being oriented with respect to the first crystal so that the extraordinary secondary beam from the laser beam passes through an ordinary path of the second birefringent crystal, and that the ordinary secondary beam from the laser beam passes through an extraordinary path of the second birefringent crystal, the pulses of the beams output from the modules reaching simultaneously and at multiple points the medium or sample to be measured.

17. The multipoint optical measuring device according to claim 16, wherein the optical axis of the second crystal of each splitting module is rotated by 90° with respect to the optical axis of the first crystal of the same splitting module.

18. The multipoint optical measuring device according to claim 16, wherein the source is configured to emit a polarized laser beam, the first crystal of each module being oriented so that the polarization of the incident beam comprises two non-zero components along the polarization axes of the ordinary and extraordinary secondary beams of said first crystal.

19. The multipoint optical measuring device according to claim 16, comprising a succession of several splitting modules interposed on the path of the beams between the converging lens and the location of the medium or sample to be measured, said succession of splitting modules extending along the path of pulses over a distance less than the focal length of the converging lens multiplied by the average index seen by the incident laser beam in each birefringent crystal.

20. The multipoint optical measuring device according to claim 16, wherein a waveplate is interposed between two successive splitting modules, said waveplate being adapted so as to rotate the polarization of the beams it receives by +/−45° or to make it circular.

21. The multipoint optical measuring device according to claim 16, comprising a succession of N splitting modules split in pairs by a waveplate, where N is an integer, the crystals of the different splitting modules having different thicknesses from one splitting module to another, said succession of modules generating 2^{N} measuring points arranged in line on the medium or sample to be measured.

22. The multipoint optical measuring device according to claim 20, wherein a waveplate is a half-waveplate or a quarter-waveplate.

23. The multipoint optical measuring device according to claim 16, comprising a succession of N splitting modules, where N is an integer, the successive splitting modules having their own optical axes rotated every other time by +/−45° in the plane orthogonal to the axis of direction of the pulses, said succession of modules generating a grid of 2^{N} measuring points on the medium or sample to be measured.

24. The multipoint optical measuring device according to claim 16, wherein the thickness of the crystals of a first splitting module, which is upstream of a second splitting module arranged downstream on the path of the beams, is of a value equal to the product of the thickness of the crystals of said second module and of a predetermined multiplier.

25. The multipoint optical measuring device according to claim 24, wherein the predetermined multiplier is 2 or 1/√2.

26. The multipoint optical measuring device according to claim 16, wherein the first and the second crystal of a splitting module are two stacked plates.

27. The multipoint optical measuring device according to claim 16, wherein the pulses emitted by the source are pulses of sub-picosecond duration.

28. A use of a multipoint optical measuring device according to claim 16, for laser spectroscopic measurement in a stationary or unsteady or turbulent flow.

29. The use of a multipoint optical measuring device according to claim 16, for hyperspectral or multiphoton microscopy measurement.

30. A multipoint optical measuring method, wherein
a. a medium or a sample to be measured is excited at several points by a multipoint optical measuring device according to claim 1 (step E1),
b. a response from the medium or sample to be measured is recorded by a matrix or sequential detector or a fiber optic bundle (step E2),
c. the response is analyzed to deduce physico-chemical parameters at each excited point (step E3).
